(19) United States
(12) Patent Application Publication
(10) Pub. No.: US 2007/0239521 A1
(43) Pub. Date: Oct. 11, 2007

(54) Method and an apparatus to define loyalty promotions

(76) Inventors: Bhushan Khadpe, Cupertino, CA (US); Victor Chau, Fremont, CA (US); Zhaogang Wo, Alameda, CA (US); Rahul Viswanathan, Fremont, CA (US); Prakash Thekkatte, Dublin, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 10/942,293

(22) Filed: Sep. 15, 2004

(51) Int. Cl. G06Q 30/00

(52) U.S. Cl. 705/14

(57) ABSTRACT

A method and an apparatus to define loyalty programs have been disclosed. In one embodiment, the method includes generating a graphical user interface (GUI) to allow a user to input information for defining a loyalty program (LP), wherein the information includes a name of the LP, a start date, an end date, a plurality of loyalty promotions, a plurality of attributes, a plurality of criteria, and a plurality of actions to be performed, receiving the information from the user, defining a plurality of rules based on the plurality of criteria and the plurality of actions, and defining the plurality of loyalty promotions using the information and the plurality of rules.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

The present invention relates to loyalty programs, and more particularly, to defining loyalty promotions and providing the corresponding loyalty processing engine.

### BACKGROUND

Today, many companies set up loyalty programs for their patrons to participate in. For example, many airlines provide frequent flyer programs to allow passengers enrolled in such programs to accrue points as the passengers fly with the corresponding airlines. The accrued points may be redeemed for rewards, such as one or more predetermined free flights, upgrades, etc. Another typical example is the frequent shopper programs provided by some grocery stores that allow shoppers to accrue points for purchasing groceries at the corresponding grocery stores. Many credit card companies also provide similar loyalty programs to reward card holders for using their credit cards to shop.

Such loyalty programs provide numerous advantages to these companies. In addition to fostering customer loyalty among existing customers in order to generate repeat business, the rewards of these programs may entice new customers to start purchasing the products and/or services offered by these companies. These companies may also collect valuable information on their customers, such as the purchasing habits of the customers in different geographical areas. Such information is helpful in developing future marketing strategies and targeted advertising.

However, the conventional way to set up a loyalty program is relatively costly and time-consuming. Typically, an existing loyalty program offered by a company is coded in a low level programming language, such as C++ or Sequential Query Language (SQL), by the information technology department of the company. There is no customizable process to define the promotions of the loyalty program in a rule-based form. Therefore, it generally takes a long time from the defining of a loyalty program to the putting of the loyalty program into production.

Furthermore, the existing loyalty programs are generally not scalable and are difficult to configure because these programs are coded in the low level programming language. As the volume of transactions of the company grows and/or the business of the company diversifies, it is difficult, if not infeasible, for the existing loyalty promotion programs to scale accordingly without any major overhaul of the code in the low level programming language.

### SUMMARY

The present invention includes a method and an apparatus to define loyalty programs, and loyalty promotions in particular. In one embodiment, the method includes generating a graphical user interface (GUI) to allow a user to input information for defining a loyalty promotion, wherein the information includes a name of the LP, a start date, an end date, a plurality of attributes, a plurality of criteria, and a plurality of actions to be performed, receiving the information from the user, defining a plurality of rules based on the plurality of criteria and the plurality of actions, and defining the plurality of loyalty promotions using the information and the plurality of rules.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 illustrates a flow diagram of one embodiment of a process to define loyalty promotions;

FIG. 2 illustrates an exemplary embodiment of a graphical user interface (GUI) according to one embodiment of the invention;

FIG. 3 illustrates another exemplary embodiment of a GUI according to one embodiment of the invention;

FIG. 4 shows a logical representation of entities according to one embodiment of the invention;

FIG. 5A shows one embodiment of a system usable with the present invention;

FIG. 5B illustrates operations on the user side and server side in a system according to one embodiment of the invention; and

FIG. 6 illustrates a flow diagram of one embodiment of a process performed by a loyalty processing engine for an exemplary loyalty program.

### DETAILED DESCRIPTION

A method and an apparatus to define loyalty promotions are described. In the following description, numerous specific details are set forth. However, it is understood that embodiments of the invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment is included in at least one embodiment of the invention. The appearance of the phrase “in one embodiment” in various places in the specification do not necessarily refer to the same embodiment.

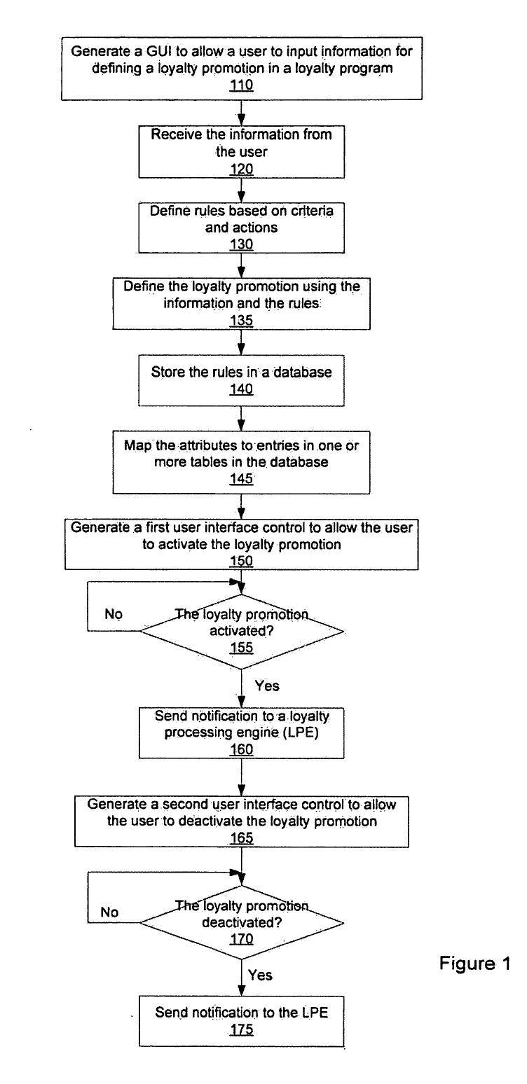

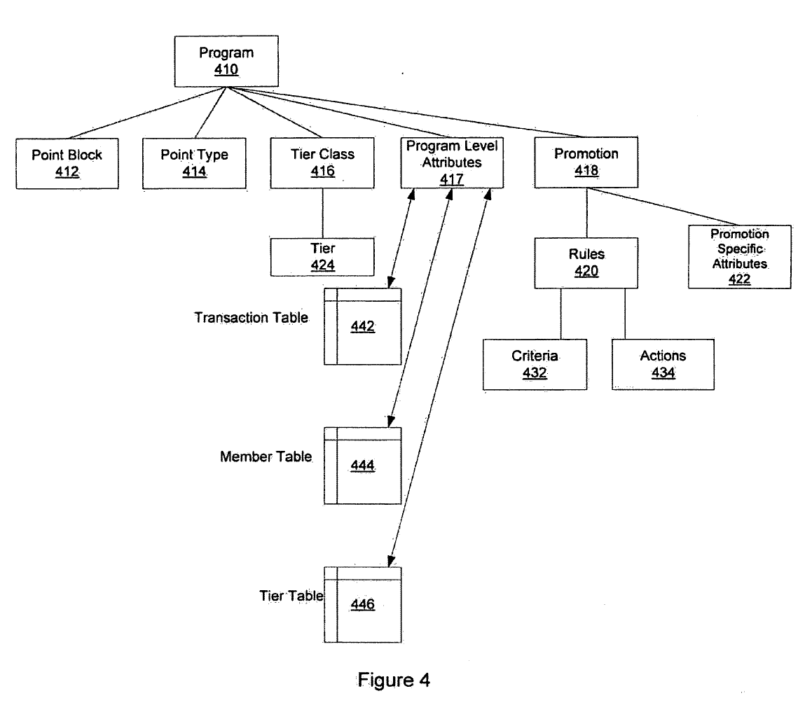

FIG. 1 shows a flow diagram of one embodiment of a process to define loyalty promotions. The process is performed by processing logic that may comprise hardware (e.g., circuitry, dedicated logic, etc.), software (such as is run on a general-purpose computer, a server, or a dedicated machine), or a combination of both. A loyalty program may include one or more promotions. Details of various types of promotions are discussed below with reference to FIG. 4.

In one embodiment, processing logic generates a graphical user interface (GUI) to allow a user to input information for defining a loyalty promotion (processing block 110). For example, a business manager of a company may input the information via the GUI. Various information may be input, such as a name of the promotion, a start date of the program, an end date of the program, the type of promotion (e.g., transaction-based, membership tier management, etc.), a set of attributes of the promotion, a set of criteria, and a set of actions to be performed if some of the criteria are met, etc. Then processing logic receives the information from the user (processing block 120).

In one embodiment, processing logic defines a number of rules for the loyalty promotion based on the criteria and actions entered (processing block 130). Alternatively, processing logic may receive the rules from the user via the GUI. In some embodiments, the rules may include both user input rules and processing logic defined rules. More details of the rules, the criteria, and the actions are discussed below with reference to FIG. 4.

Processing logic defines the loyalty promotion using the information and the rules (processing block 135). Processing logic may store the rules in a database (processing block 140). The term “database” as used in the current description may include one or more data storage devices (e.g., optical drives, magnetic disks, etc.) and/or data storage systems. The database may further store one or more tables and processing logic may map the attributes to the entries in the one or more tables (processing block 145). Various types of tables may be defined based on the type of the loyalty program. Examples of these tables include transaction tables, member tables, tier tables, etc. More details of the attributes are discussed below with reference to FIG. 4.

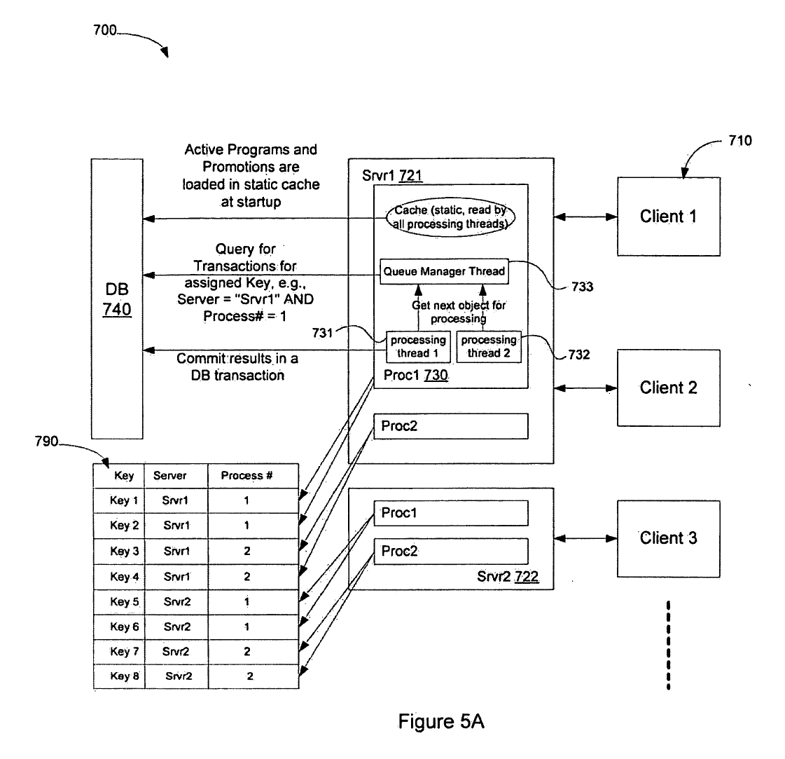

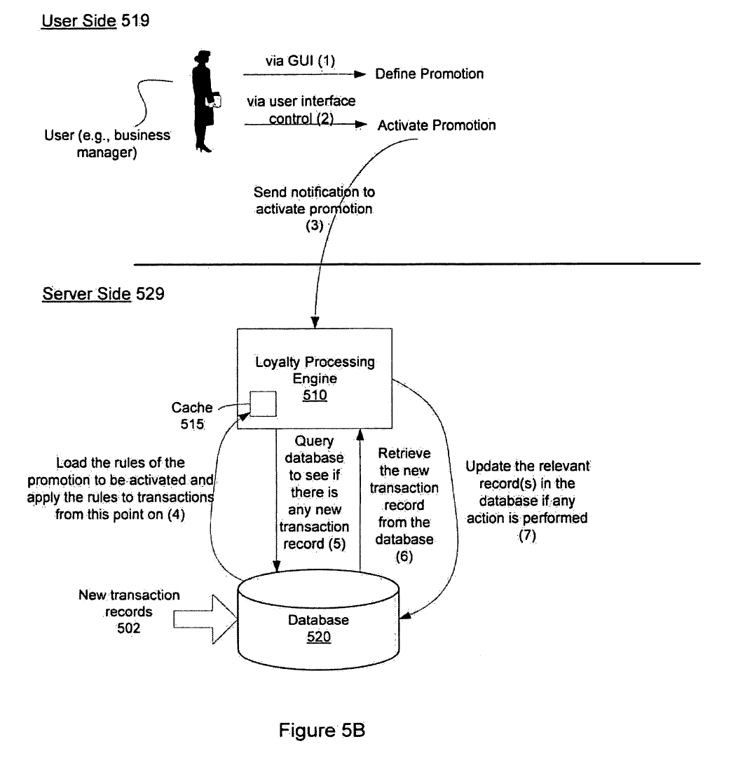

In one embodiment, processing logic generates a first user interface control (e.g., an activate button in the GUI) to allow the user to activate the loyalty program (processing block 150). After generating the first user interface control, processing logic polls whether the user has activated the loyalty promotion (processing block 155). If the loyalty promotion has not been activated yet, processing logic remains in processing block 155 to keep polling. Otherwise, processing logic sends a notification to one or more loyalty processing engines (LPE) associated with the loyalty promotion (processing block 160). In one embodiment, the LPE is a server component running on an application server. There may be multiple LPEs running on a single application server. Alternatively, each of the multiple LPEs may run on a different application server. Details of the LPE and the system architecture according to one embodiment of the invention are discussed below with reference to FIG. 5A. The notification of the activation of the loyalty program may cause the one or more LPEs to load the rules and other related data of the loyalty program into a cache of the application server so that the LPEs may start applying the rules to various transactions to evaluate the transactions for the loyalty program.

In one embodiment, the first task the LPE does as the LPE starts up is to load the rules of the active programs and/or data (e.g., definitions) associated with the loyalty program into the cache. The LPE may load the current version of the rules of the programs and data from the database, and hence, the LPE may restart in order to load any changes to the program and/or data after the previous loading. In some embodiments, the contents of the cache are loaded from the business components in a loyalty engine cache manager business object running on the application server.

When the user actuates the user interface control (e.g., an activate button) to activate a new version of a loyalty promotion, processing logic may send a component request to each of the running processes of the LPEs. Objects that are processed before the user hits the activate button may use the previous version of the loyalty promotion and objects that are processed after the user hits the activate button may use the new version. Furthermore, processing logic may provide another user interface control, such as a modify button, to allow the user to make the loyalty program inactive while leaving the programs in the cache. When the modifications of the loyalty promotion are done, the user may actuate the activate button so that the new version of the loyalty promotion is refreshed in the cache.

Furthermore, when the loyalty promotion is activated, processing logic may run some validation conditions on the loyalty promotion to make sure the loyalty promotion has all the necessary information correctly defined. Various conditions are validated, such as, for example, the number of rules is at least one, each rule has at least one action, no product is specified in the GUI if the loyalty promotion includes all products, etc.

In some embodiments, more than one loyalty promotion can be activated. One or more LPEs may load the rules and the related data of each of the activated loyalty promotoin into the cache and the LPEs may apply the rules to the relevant transactions.

In one embodiment, processing logic generates a second user interface control (e.g., a deactivate button in the GUI) to allow the user to deactivate the loyalty promotion (processing block 165). After generating the second user interface control, processing logic polls whether the user has deactivated the loyalty promotion (processing block 170). If the loyalty promotion has not been deactivated yet, processing logic remains in processing block 170 to keep polling. Otherwise, processing logic sends a deactivation notification to the LPE (processing block 175). The deactivation notification may cause the LPE to stop applying the rules to any transaction from that point on. Processing logic may further remove the rules from the cache.

One should appreciate that the operations described above are for illustrating the concept. Various embodiments of the process may include different combinations of these operations in different sequences.

By providing one or more GUIs to receive input of loyalty promotion information and defining the loyalty promotion automatically, the loyalty promotion can be defined and activated within minutes without having a team of programmers to write programs in a low level program language to implement the loyalty program which may take weeks or months to complete. Furthermore, by deploying the loyalty promotion using one or more LPE, the system may be readily scaled by adding or removing LPEs to meet the current workload.

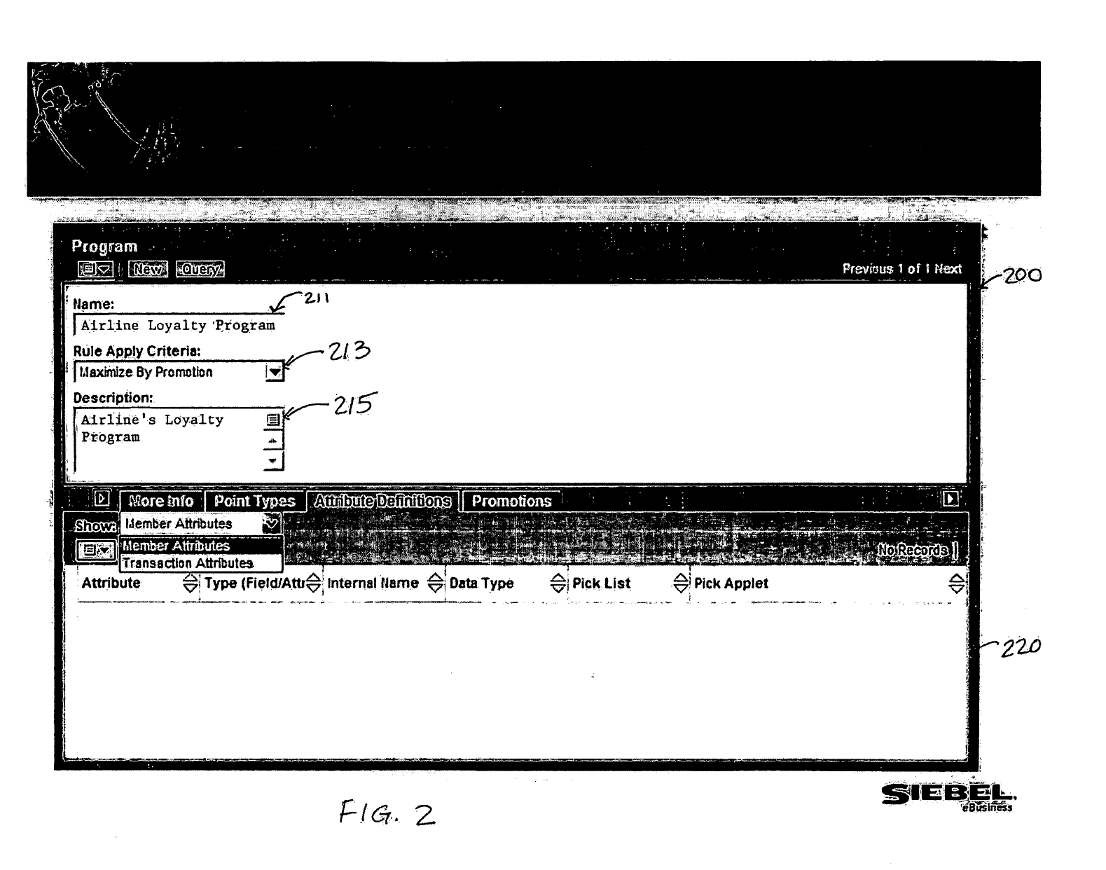

FIG. 2 illustrates an exemplary GUI according to one embodiment of the invention. The GUI 200 includes a field 211 for inputting the name of the loyalty program. The GUI 200 further includes a drop down selection menu 213 to allow a user to select the rule apply criteria. Another text field 215 is provided for inputting the description of the loyalty program. The text field 220 is provided for inputting the definitions of the attributes. In one embodiment, the attributes are categorized by the type of the attributes, such as member attributes, transaction attributes, etc. It should be appreciated that the GUI 200 is merely an example to illustrate the concept. More or fewer fields may be provided in other GUIs according to other embodiments of the invention.

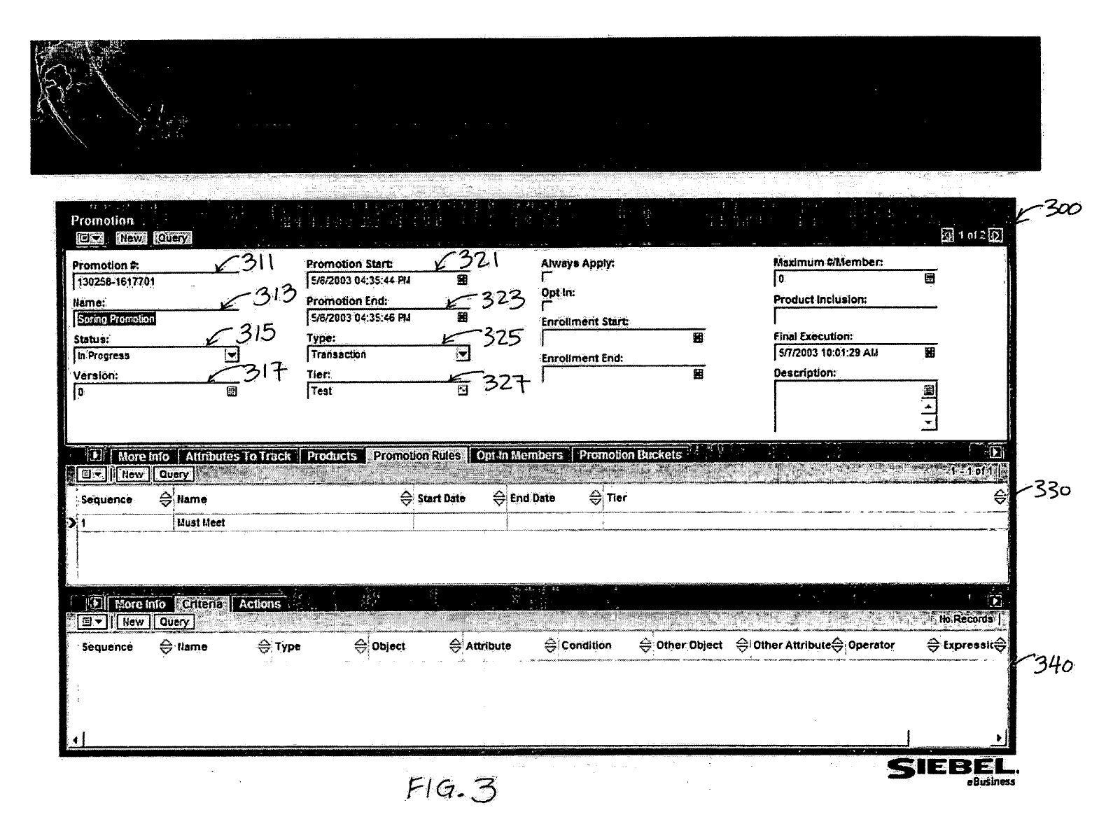

FIG. 3 illustrates an alternative GUI according to one embodiment of the invention. The GUI 300 includes a text field 311 for inputting the promotion number, a text field 313 for inputting the name of the promotion program, a drop down selection menu 315 for inputting the status of the promotion program, a numerical field 317 for inputting the version number of the promotion program. In one embodiment, the GUI 300 further includes a first date and time field 321 for inputting the start date, a second date and time field 323 for inputting the end date, a drop down selection menu 325 for selecting the type of the promotion program, and another drop down selection menu 327 for selecting the tier of the promotion program. A table 330 is included in the GUI 300 to allow the user to input the rules of the promotion. Another table 340 is provided to allow entry of the criteria of the promotion. It should be appreciated that the GUI 300 is merely one example to illustrate the concept. More or fewer fields may be provided in other GUIs according to other embodiments of the invention.

FIG. 4 shows a logical representation of various entities of a loyalty program according to one embodiment of the invention. The entities of the loyalty program include a program entity 410, a point block entity 412, a point type entity 414, a tier class entity 416, a set of program level attributes 417, a promotion entity 418, a tier entity 424, rules 420, promotion specific attributes 422, criteria 432, and actions 434. The point block entity 412, the point type entity 414, the tier class entity 416, the program level attributes 417, and the promotion entity 418 depend from the program entity 410, which is also referred to as a parent of the aforementioned entities. The tier 424 depends from the tier class entity 416. The rules 420 and the promotion specific attributes 422 depend from the promotion entity 418. The criteria 432 and the actions 434 depend from the rules 420. The descriptions of these entities according to one embodiment of the invention are summarized in Table 1 below. Note that the entities and the definitions of the entities in Table 1 may vary in different embodiments.

TABLE 1
Descriptions of Entities according
to one embodiment of the invention

| Entity | Description |
|---|---|
| Program | Program 410 is the highest level entity in the loyalty |
| 410 | system. The other entities, such as promotion 418, are |
| | children of program 410. |
| Point | Point block 412 represents a given number of points |
| Block 412 | that a partner of the loyalty program has paid for and |
| | are given to members when the members qualify for |
| | promotion 418 sponsored by that partner. |
| Point | A point type 414 represents a type of point that is |
| Type 414 | awarded as part of the loyalty program. For each point |
| | type, it can be either qualifying or non-qualifying type. |
| Tier | A tier class 416 represents a group of tiers for which a |
| Class 416 | member can have one value in each tier class and can |
| | move from one tier to another within the tier class |
| | based on the tier rules. |
| Tier 424 | A tier 424 is a state of a member within a tier class. |
| | The member can move from one tier to another within the |
| | tier class. |
| Program | Program level attributes 417 represent properties of |
| Level | various objects, such as transactions, members etc., that |
| Attributes | are used during the processing by a loyalty processing |
| 417 | engine. Depending on the type of attribute definitions, |
| | the attributes 417 can be used in criteria for comparing |
| | values and/or in actions to update their values. These |
| | attributes 417 can be used by all promotions in the |
| | program. |
| Promotion | The promotion 418 represents the rules, actions, |
| 418 | members, products, and all other information affecting |
| | the execution of a loyalty promotion. Note that a |
| | program 410 may have one or more promotions 418. |
| Promotion | The promotion specific attributes 422 are a special type |
| Specific | of attribute definitions that track the behavior of a |
| Attributes | member for a particular promotion. These attributes 422 |
| 422 | may be only used by the promotion it is defined for. |
| Rules | A promotion 418 is composed of multiple rules 420. |
| 420 | Each rule is a list of conditions (also referred to as |
| | criteria) that the object being processed has to satisfy |
| | in order to qualify for the rule. When a rule is |
| | qualified, the actions listed in the rule are performed. |
| Criteria | The criteria 432 that a transaction has to satisfy in |
| 432 | order to qualify for a rule. |
| Actions | The action(s) 434 to be performed when a rule is |
| 434 | qualified. |

As mentioned before, there may be one or more promotions in a loyalty program. Thus, there may be one or more promotion entities 418 defined in a loyalty program. Each promotion entity 418 may have various fields specified. Some examples of the promotion fields according to one embodiment of the invention are described below in Table 2. Note that the promotion fields and the definitions of the promotion fields in Table 2 may vary in different embodiments.

TABLE 2
Examples of the promotion fields according
to one embodiment of the invention

| Field | Description |
|---|---|
| Promotion # | A unique number generated automatically for the |
| | promotion. |
| Name | Name of the promotion. |
| Apply To* | A pre-filter that should be met by the transaction |
| | to be considered for this promotion. |
| Tier | The tier to which the promotion applies (only |
| | in the case of Tier Promotions). |
| Active | Flag indicating if the promotion is active. |
| Always Apply | Flag indicating if the promotion always applies |
| | or not |
| Enrollment Required* | Flag indicating if members need to enroll for |
| | this promotion so as to be considered for it. |
| Promotion Start* | Start date of the promotion. |
| Promotion End* | End date of the promotion. |
| Enrollment Start | Start date for enrolling in the promotion. |
| Enrollment End | End date for enrolling in the promotion. |
| Product Inclusion* | List of Values bounded field for any condition |
| | that should be met by the product on the |
| | transaction. |
| Point Limit Type | LOV bounded field determining how to limit |
| | the points assigned from the promotion. |
| Partner | Partner who is sponsoring this promotion. |
| Organization | Multi-valued field for providing visibility. |
| | The LPE may not use this field. |
| Description | Free text description about the promotion. |

*This field determines a pre-qualification condition described below.

In some embodiments, there are a number of pre-qualification conditions driven by some of the above fields. Note that these pre-qualification conditions may be applied to transaction processing, but not the processing of other types of objects. Some of these pre-qualification conditions include checking promotion start and promotion end dates, checking whether enrollment is required for the promotion, checking product inclusion, and checking whether the promotion is applicable to the object. Each of the above exemplary pre-qualification conditions is described in detail below.

Before processing a transaction, the transaction date field may be checked to determine whether the transaction date is between the promotion start date and the promotion end date. Furthermore, if the enrollment required flag is checked, then a member has to be enrolled for the promotion. If the member is not enrolled, then the transactions of this member are not evaluated for this promotion. For product inclusion, there may be three possible settings, namely, All Products, Include Products, and Exclude Products. If the setting is All Products, the promotion applies to all products and no check is performed on the product. If the setting is Include Products, the promotion applies to only those transactions whose product is specified for this promotion. If the setting is Exclude Products, the promotion applies to only those transactions whose product is not specified for this promotion.

In some embodiments, there is a pre-filter condition that has to be met by the transaction before applying the corresponding promotion to the transaction. One purpose of this pre-filter condition is to filter out different types of promotions. For example, there are some administrative promotions for processing redemption, cancellation, etc., and there are some promotions that are considered only for accrual transactions. In one embodiment, the Apply To field allows pre-filtering of the promotions that are considered for a transaction based on its type, sub-type, or other criteria. In some embodiments, if the promotion has a value specified in the Apply To field, then the LPE may first get the value of the corresponding field from the transaction. If the value in the corresponding field is yes, then the promotion is considered for the transaction. If the value in the corresponding field is empty, then this pre-qualification condition is ignored and the promotion is applied to the transaction meeting the other pre-qualification conditions in effect.

Based on the purpose of the loyalty program, various promotions may be defined, such as loyalty base promotions, also referred to as loyalty admin promotions (e.g., point accrual, redemption, cancellation, voucher, action based bonus, etc.), loyalty rewards promotions (e.g., simple promotions, frequency promotions, complex promotions, action based bonus promotion, etc.), and tier promotions, etc.

In some embodiments, a promotion can be a loyalty promotion or a tier promotion depending on the type of objects the promotion is applied to. A loyalty promotion is a promotion that is applied to transactions. Loyalty promotions typically perform actions that reward a member for his transactions or behavior over a period of time. Unlike the loyalty promotion, the tier promotion defines the rules that are applied to a tier so as to determine if the tier can be changed to another level (e.g., upgrade, downgrade, re-qualify, etc.) based on the attributes of the member. The tier promotion is applied to a member tier and only one tier promotion can be considered for a given tier, unlike the loyalty promotions, where multiple promotions may be considered for each transaction.

Referring back to FIG. 4, the rules 420 depend from the promotion entity 418. A promotion may be composed of one or more rules. Each rule is a list of criteria 432 (also referred to as conditions) that the object being processed has to satisfy in order to qualify for the rule. When a rule is qualified, one or more of the actions 434 that are listed in the rule are performed. For example, one of the criteria in an exemplary frequent flyer program of an airline is flying from San Francisco to Boston and an action to be performed if this criterion is met is to add 500 points to the member's account. The corresponding rule is, therefore, adding 500 points to a member's account if the member flies from San Francisco to Boston. Another example of the rules 420 is doubling the points added to a member's account if the member flies first class. Within a promotion, the rules 420 may be evaluated in the order of their sequence number until a rule is qualified. Note that only one rule can qualify from each promotion. When a rule of a promotion is qualified, a LPE may evaluate the actions listed in the rule and then move onto the next promotion.

As discussed above, the criteria 432 are condition expressions that evaluate to true or false. In some embodiments, all the criteria of a rule have to evaluate to true in order for the rule to be qualified. However, some rules may not have any criteria defined. In that case, only the pre-qualification conditions described above are evaluated. If the pre-qualification conditions are met, then the rule is qualified. There are various types of criteria, such as compare to values, compare to object, evaluate roundtrip, etc. Each of these three exemplary criteria types is described below in detail.

The compare to values type of criteria allow the user to compare the value of one attribute to one or more constant values. For example, the condition Equals (“=”) allows comparing to multiple values, e.g., Type=Product OR Type=Cancellation. However, the condition Is Greater Than (“>”) may allow comparing to only one value, e.g., Points>10. The values being compared to may or may not be specified depending on the condition selected. A value may be specified by creating a new record and saving the record.

Another type of criteria is the compare to object type, which allows the user to compare the attributes with one another. In some embodiments, the user can also specify a constant in an expression to be used in this type of comparison. For example, the user may specify the following comparison: [Numeric Attribute A]>[Numeric Attribute B]*2.

Another type of criteria that may be used in a promotion for a frequent flyer program is Evaluate Roundtrip. This type of criteria allows the user to check if a flight transaction is part of a roundtrip. These criteria may evaluate to TRUE if the roundtrip has been completed. A corresponding rule may have various actions, such as awarding bonus points, etc. Furthermore, the round trip information may be updated for subsequent use in the promotion.

Referring back to FIG. 4, in addition to the criteria 432, the actions 434 also depend from the rules 420. An action is an operation or a sequence of operations to be performed when a rule is qualified. Each rule may have at least one action specified. Different types of actions are available depending on the context in which the rule is being defined, such as the type of promotion (e.g., loyalty, tier, etc.), the type of rule (e.g., transaction, attribute, etc.), etc. Various exemplary action types are discussed below.

One type of actions is tier change actions. The tier change actions are available in the context of defining tier promotions. The tier change actions may include various types of actions, such as upgrade tier, downgrade tier, qualify tier, and re-qualify tier. The upgrade and downgrade tier actions may require the specification of a tier to upgrade or downgrade to. Unlike the upgrade and downgrade tier actions, the qualify and re-qualify tier actions may not require additional information to be specified.

A second type of actions is expression-based actions. Examples of the expression based actions include assign points, redeem points, and update attributes, etc. The expression based actions involve calculating the value of an expression, which may also be a constant, and performing the appropriate action, such as assigning the points calculated to a predetermined member, redeeming the points calculated, or changing the value of an attribute by the calculated value.

Besides the above two types of actions, other types of actions may be available in some embodiments, such as cancel transaction, update roundtrip information, invoke custom action to invoke a customer defined procedure for performing customized processing, etc.

Referring back to FIG. 4, there are two types of attributes, namely, the program level attributes 417 and the promotion specific attributes 422. In one embodiment, the definitions of both types of attributes represent various properties of different objects that can be used during the processing of objects for a particular promotion or all promotions in the loyalty program. For example, some of the attribute definitions represent fields on business components, such as transactions, members, etc. Some sample attribute definitions for an exemplary promotion according to one embodiment of the invention are described in Table 3 below. Note that the attributes and the definitions of the attributes in Table 3 may vary in different embodiments.

TABLE 3
Sample attribute definitions for an exemplary promotion
according to one embodiment of the invention

| | | | Availability |
|---|---|---|---|
| | | | Context |
| | | | Promotion |
| Attribute | | | Type/Rule |
| Definition | Description | Read-only | applies to |
| Member | Name-Value pairs | No | All |
| Attributes | maintained for each | | |
| | member of the loyalty | | |
| | program. These | | |
| | instances may be | | |
| | created only when it | | |
| | has to be updated for | | |
| | a member for the first | | |
| | time. Until then, it | | |
| | may not exist for the | | |
| | corresponding member. | | |
| Member Field | Fields of the Member. | Conditional | All |
| Attributes | | | |
| Member Tier | Fields of the Member | Conditional | Tier/Tiers |
| Attributes | Tier. | | |
| Point Totals | Runtime summation of | Always | All |
| Attributes | the points of the | | |
| | specified type accrued | | |
| | over the specified | | |
| | number of months. | | |
| Transaction | Fields of the | Always | Loyalty/ |
| Attributes | Transaction | | Transactions |
| Promotion | Fields of the Promotion | Conditional | Loyalty/ |
| Specific | Bucket | | Attributes |
| Attributes | | | |
| Member Tier | This is a special type | Always | All |
| Class | of member attribute for | | |
| | each tier class. It | | |
| | provides access to the | | |
| | current value of a | | |
| | member's tier within | | |
| | a tier class. This | | |
| | attribute definition | | |
| | may be created | | |
| | internally for each | | |
| | tier class and may | | |
| | not be exposed to | | |
| | the user. | | |

Furthermore, the program level attributes 417 and the promotion specific attributes 422 may be mapped to some entries in one or more tables, such as transaction tables, member tables, tier tables, etc. Different types of tables may be defined for different types of promotions. For example, a tier attribute from a tier table may be used for a tier-type promotion but not a transaction-type promotion. Furthermore, the tables may be expandable such that additional attributes may be added readily by expanding the tables to accommodate more entries.

FIG. 5A illustrates one embodiment of a system usable with the present invention. In one embodiment, the system 700 includes a number of client machines 710, a number of application servers 721-722, and a database 740. The client machines 710 are communicably coupled to one or more of the application servers 721-722. Each of the application servers 721-722 may include one or more server components. The server components may include one or more loyalty processing engines (LPE), such as the LPE 730 running on the application server 721. Each of the LPE may be communicably coupled to the database 740 to perform various operations, such as to query the database 740, to retrieve records from the database 740, to update records, or to commit results in the database 740, etc. The system 700 may be usable to implement various embodiments of the invention described above.

Note that any or all of the components and the associated hardware illustrated in FIG. 5A may be used in various embodiments of the system 700. However, it should be appreciated that other configurations of the system 700 may include more or less components than those shown in FIG. 5A. Moreover, the system 700 may be part of an enterprise networked server system that provides enterprise software to an organization and the operations described above may be implemented by the enterprise software, the hardware components of the server system, or a combination of both. Furthermore, the components in the system 700 may be coupled to each other via wire or wireless links. Hence, the components in the system 700 may be located in the same sites or in different sites.

Referring back to FIG. 5A, the logical mapping of server keys in a table 790 is shown with the system 700. In one embodiment, the server keys used by the LPE 730 enable the distribution of the members across different servers and processes so as to allow static load balancing. Furthermore, using the server keys may ensure that only one process is processing a member at any given time. Within a process, the LPE 730 ensures that only one of its processing threads (e.g., 731 and 732) is processing a member at any given time. Each server key may have a unique name. Different numbers of members may be assigned to a server key, such as 1, 2, etc. The server and process number determine which server the server key is assigned to. There may be more than one server key assigned to the same combination of server and process number.

In one embodiment, the number of server keys is determined at the deployment of the LPEs (e.g., the LPE 730). An administrator of the system 700 may be aware of the number of servers available and the number of server processes required to process the load of transactions within a predetermined period of time. For example, if it has been determined that five server processes are required to process the transaction load and there are two servers available in the system 700, where one of the servers is already running another process, then two of the five processes can be distributed on one server and the remaining three on the other server. To achieve load balancing, five server keys may be defined and assigned to the appropriate server and process number combinations as follows in one embodiment:

| Server Key | Server | Process # | # of Members |
|---|---|---|---|
| Key 1 | srvr1 | 1 | 0 |
| Key 2 | srvr1 | 2 | 0 |
| Key 3 | srvr2 | 1 | 0 |
| Key 4 | srvr2 | 2 | 0 |
| Key 5 | srvr2 | 3 | 0 |

In the above example, all the members may be substantially equally and randomly distributed across the server keys. If there are existing members when the LPE is deployed, then some of the server keys are assigned to these existing members. The new members may be automatically assigned the least loaded server key in terms of the number of members already assigned to the server keys.

In some embodiments, additional server keys may be defined to provide more flexibility in load balancing. For instance, ten times the number of server keys as the number of processes required (i.e., 50 server keys) may be defined in the above example. The 50 server keys may be named as Key 1-01 to Key 1-10, Key 2-01 to Key 2-10, and so on. Other unique names may be used in other embodiments. Since ten times the server keys have been defined in this example, the server and process number for each set of ten server keys are the same. If deemed necessary due to increased or changed transaction distribution, with the additional server keys, the administrator may move some of the server keys from one server and process number combination to another for load balancing. Note that the defining of additional server keys may not impact the performance of the system 700.

The LPE 730 may be deployed as a server component. In one embodiment, the LPE 730 runs in the background to process eligible objects, such as transactions, tiers, etc. The LPE 730 is also referred to as a batch component in this scenario. The batch component is a multi-threaded component that can be deployed to run multiple processes on multiple application servers, such as Srvr1 721 and Srvr2 722. Alternatively, the LPE 730 may run in a real-time mode to process requests from the clients 710 on demand. The LPE 730 is also referred to as a real-time component in this scenario.

In one embodiment, each process or processing thread, such as processing threads 731 and 732, processes transactions assigned to the server keys that have been registered by that process. Within each process, the cache is treated as a static object that is loaded at startup. The cache may contain the active programs and promotions that are used to process objects, such as transactions. The cache may be viewed as the master data.

Among all the threads within the LPE 730, the first thread may assume the role of the queue manager thread 733. Thus, the remaining threads may become processing threads. The queue manager thread is responsible for various tasks, such as acquiring the server key for which to process transactions, initializing the cache object, initializing the queue of objects to be processed by the processing threads, re-querying the database 740 for new objects to fill the queue when all the objects in the queue has been processed and the queue is empty. On the other hand, the processing threads may request objects (e.g., transactions, tiers, etc.) from the queue manager to process the objects. For each object, the results may be committed by the processing threads in a database operation.

For each request submitted from one of the clients 710, the real-time component may start a separate task to process the object. Once the task is completed, the real-time component may exit. The real-time component may run in a synchronous mode or an asynchronous mode. In the synchronous mode, the client 710 may wait for the transaction processing to be completed and return control back to the client only when the processing is done. The user cannot do anything until the processing is completed. When control is returned to the user, the record would have been refreshed to reflect any changes, such as change in status, number of points, etc. In contrast, in the asynchronous mode, the client may submit a component request and control is returned substantially immediately. This allows the user to continue with his work, but the user may have to re-query the transaction to see if the processing is completed (e.g., by checking the status) and to check the results.

The decision to use synchronous or asynchronous mode may depend on the load in the particular deployment. In one embodiment, transaction processing takes a fraction of a second and a sub-second response is expected with only a few hundreds of users and a light to medium load, then synchronous mode may be used. But if there are thousands of users all using real-time processing, then the asynchronous mode may be preferred.

Furthermore, the real-time component is an unkeyed component, which does not restrict itself to any key and processes any given object as long as the object also meets the search specification of the real-time engine. Since the real-time engine is unkeyed, the real-time component is configured as a single process component and is enabled on only one server in the system 700.

Unlike the real-time component, the batch component is responsible for backend processing. Once started, the batch component runs in the background without any user intervention and processes objects as the objects are created in the database 740. Each of the tasks continues to wait for more objects to process until the batch component or the server on which the batch component runs is shutdown.

In one embodiment, the batch component is started each time the server is brought up. However, the batch engine may not be configured to start automatically on server startup. In some embodiments, the configuration of the batch component is automated in a workflow or a scripted business service, which can be invoked upon server startup.

Furthermore, the batch component is a keyed component, which registers a key with the system 700 and processes objects only for that key. This allows the batch component to be deployed on multiple servers for load balancing.

FIG. 5B illustrates operations on the user side and server side in a system according to one embodiment of the invention. On the client side 519, the operations may be performed by a user (e.g., a business manager), one or more client machines (e.g., personal computers, workstations, etc.), or a combination of both. On the server side 529, the operations may be performed by one or more server components (e.g., the loyalty processing engine 510) running on one or more servers.

In one embodiment, the user defines a loyalty program, which may include one or more promotions, via a first GUI (operation (1)). The user may input information on the promotion via the first GUI. Some examples of the information that may be input have been described above with reference to FIGS. 1-3. Based on the information, some rules of the promotion are defined and stored in a database 520. After defining the promotion, the user may activate the promotion via a user interface control, such as an activate button (operation (2)). The user interface control may be incorporated into the first GUI or into a second GUI. When the user activates the promotion, the client machine may notify the loyalty processing engine (LPE) 510 on the server side that the promotion has been activated (operation (3)). Details of the LPE 510 have been discussed above with reference to FIG. 5A.

In response to the notification, the LPE 510 may load the rules of the promotion from the database 520 into a cache 515 associated with the LPE 510 (operation (4)). In some embodiments, the cache 515 is implemented by a temporary storage device on the application server running the LPE 510. Once the rules of the promotion have been loaded into the cache 515, the LPE 510 may apply the rules to the transactions.

In one embodiment, records of the transactions are stored in the database 520. The LPE 510 may query the database 520 to check if there is any new transaction record 502 input into the database 520 (operation (5)). If so, the LPE 510 may retrieve the new transaction record and apply the rules to the new transaction record (operation (6)). Based on the results of applying the rules to the transaction records, the LPE 510 may update the relevant records (e.g., the records of the member of the promotion) in the database 520 if there is any action performed (operation (7)). In one embodiment, the LPE 510 may commit the results to the database 520 in a single operation. Depending on the rules, various actions may be performed, such as adding points to the account of a member, upgrading a member to a higher tier, downgrading a member to a lower tier, etc.

One should appreciate that the operations described above are for illustrating the concept, not limiting. Other embodiments may include more or less operations than those described above in different order.

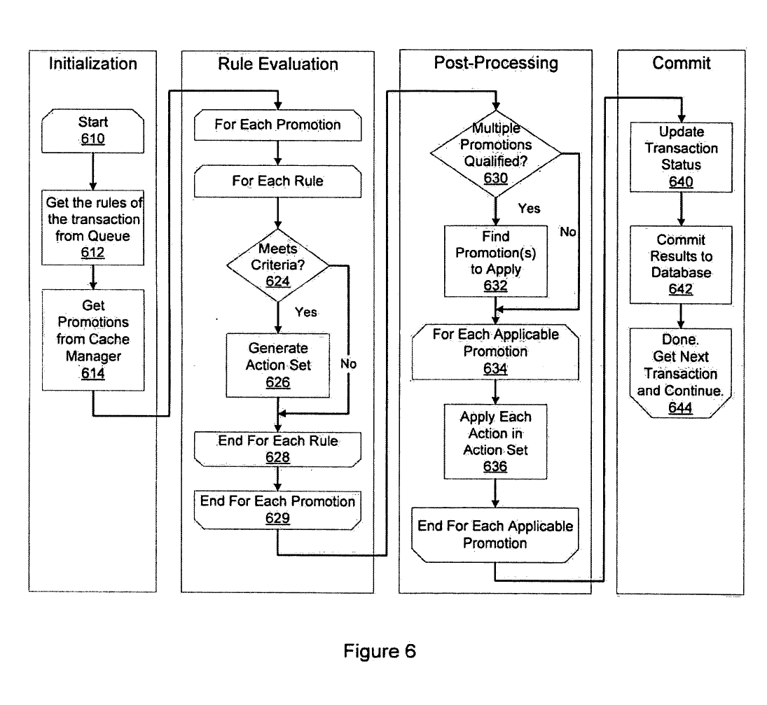

FIG. 6 illustrates a flow diagram of one embodiment of a process performed by a loyalty processing engine (e.g., the LPE 510 in FIG. 5B) for an exemplary loyalty program or promotion. The process is performed by processing logic that may comprise hardware (e.g., circuitry, dedicated logic, etc.), software (such as an LPE running on an application server or a dedicated machine), or a combination of both.

In one embodiment, the process is divided into four stages, namely, initialization, rule evaluation, post-processing, and commit. In the initialization stage, processing logic starts at processing block 610. Then processing logic gets a transaction from a queue (processing block 612). Processing logic may get the rules of one or more promotions from a cache manager (processing block 614). The cache manager may include software, hardware, or a combination of both to manage a cache on the application server.

Processing logic then transitions into the rule evaluation stage. For each promotion, processing logic evaluates each rule of the corresponding promotion. For each rule, processing logic may check whether the transaction meets the criteria of the rule (processing block 624). If the transaction meets the criteria, then processing logic generates a set of actions to be performed based on the rules (processing block 626) before transitioning to processing block 628. Otherwise, processing logic transitions to processing block 628 to evaluate the next rule. After evaluating all the rules of the corresponding promotion, processing logic transitions to processing block 629 to process the next promotion.

When processing logic has processed all the promotions, processing logic goes into the post-processing stage. In one embodiment, processing logic checks whether multiple promotions are qualified (processing block 630). If so, processing logic finds the corresponding promotion(s) to apply (processing block 632) before transitioning into processing block 634. If not, processing logic transitions into processing block 634. For each applicable promotion, processing logic applies each action in the set of actions (processing block 636). After going through all the applicable promotion(s), processing logic transitions into the commit stage.

In the commit stage, processing logic may update the transaction status (processing block 640). Then processing logic may commit the results to a database (e.g., the database 520 in FIG. 5B) (processing block 642). Then processing logic is done with the transaction. Processing logic may get the next transaction and repeat the operations on the next transaction (processing block 644).

One should appreciate that the operations described above are for illustrating the concept, not limiting. Other embodiments may include more or less operations than those described above.

Some portions of the preceding detailed description have been presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations described herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A method comprising:
generating a graphical user interface (GUI) to allow a user to input information for defining a loyalty program (LP), wherein the information includes a name of the LP, a start date, an end date, a plurality of attributes, a plurality of loyalty promotions, a plurality of criteria, and a plurality of actions to be performed;
receiving the information from the user;
defining a plurality of rules based on the plurality of criteria and the plurality of actions; and
defining the plurality of loyalty promotions using the information and the plurality of rules.

2. The method of claim 1, further comprising:
storing the plurality of rules in a database; and
mapping the plurality of attributes to a plurality of entries in one or more tables stored in the database, the one or more tables being associated with the LP.

3. The method of claim 2, wherein the one or more tables include at least one of a transaction table, a member table, and a tier table.

4. The method of claim 3, wherein the one or more tables are expandable.

5. The method of claim 2, further comprising:
generating a first user interface control to allow the user to activate one of the plurality of loyalty promotions; and
notifying a loyalty processing engine (LPE) upon the user activating the loyalty promotion to cause the LPE to load the plurality of rules from the database into a cache of a server and to apply the plurality of rules to transactions occurred between the start date and the end date, wherein the LPE is a server component running on the server.

6. The method of claim 5, further comprising:
using the LPE to query the database for records of the transactions after the loyalty promotion has been activated.

7. The method of claim 6, further comprising:
using the LPE to determine whether transactions associated with a member of the LP meet one or more of the plurality of criteria; and
performing one or more of the plurality of actions based on the plurality of rules if the transactions meet the one or more of the plurality of criteria.

8. The method of claim 5, further comprising:
generating a second user interface control to allow the user to deactivate the loyalty promotion; and
notifying the LPE upon the user deactivating the loyalty promotion to cause the LPE to remove the plurality of rules from the cache of the server.

9. The method of claim 2, wherein the plurality of rules comprises one or more promotion rules, wherein members of the LP are transferred to different tiers based on the one or more promotion rules.

10. The method of claim 1, wherein generating the GUI comprises:
generating a plurality of fields in the GUI, wherein each of the plurality of fields is operable to receive from the user one of the plurality of attributes or a constant value.

11. A machine-accessible medium that stores instructions which, if executed by a processor, will cause the processor to perform operations comprising:
generating a graphical user interface (GUI) to allow a user to input information for defining a loyalty program (LP), wherein the information includes a name of the LP, a start date, an end date, a plurality of loyalty promotions, a plurality of attributes, a plurality of criteria, and a plurality of actions to be performed;
receiving the information from the user;
defining a plurality of rules based on the plurality of criteria and the plurality of actions; and
defining the LP using the information and the plurality of rules.

12. The machine-accessible medium of claim 11, wherein the operations further comprise:
storing the plurality of rules in a database; and
mapping the plurality of attributes to a plurality of entries in one or more tables stored in the database, the one or more tables being associated with the LP.

13. The machine-accessible medium of claim 12, wherein the one or more tables include at least one of a transaction table, a member table, and a tier table.

14. The machine-accessible medium of claim 13, wherein the one or more tables are expandable.

15. The machine-accessible medium of claim 12, wherein the operations further comprise:
generating a first user interface control to allow the user to activate one of the plurality of loyalty promotions; and
notifying a loyalty processing engine (LPE) upon the user activating the loyalty promotion to cause the LPE to load the plurality of rules from the database into a cache of a server and to apply the plurality of rules to transactions occurred between the start date and the end date, wherein the LPE is a server component running on the server.

16. The machine-accessible medium of claim 15, wherein the operations further comprise:
using the LPE to query the database for records of the transactions after the loyalty promotion has been activated.

17. The machine-accessible medium of claim 16, wherein the operations further comprise:
using the LPE to determine whether transactions associated with a member of the LP meet one or more of the plurality of criteria; and
performing one or more of the plurality of actions based on the plurality of rules if the transactions meet the one or more of the plurality of criteria.

18. The machine-accessible medium of claim 15, wherein the operations further comprise:
generating a second user interface control to allow the user to deactivate the loyalty promotion; and
notifying the LPE upon the user deactivating the LP to cause the LPE to remove the plurality of rules from the cache of the server.

19. The machine-accessible medium of claim 12, wherein the plurality of rules comprises one or more promotion rules, wherein members of the LP are transferred to different tiers based on the one or more promotion rules.

20. The machine-accessible medium of claim 11, generating the GUI comprises:
generating a plurality of fields in the GUI, wherein each of the plurality of fields is operable to receive from the user one of the plurality of attributes or a constant value.

21. A system comprising:
a database to store a plurality of transaction records;
a client machine operable to generate a graphical user interface (GUI) to allow a user to input information to define a loyalty program (LP), the information including a name of the LP, a start date, an end date, a plurality of loyalty promotions, a plurality of attributes, a plurality of criteria, and a plurality of actions to be performed, wherein a plurality of rules defined using the plurality of criteria and the plurality of actions are stored in the database; and
a server coupled between the client machine and the database, the server comprising at least one loyalty processing engine (LPE) operable to apply the plurality of rules to one or more of the plurality of transaction records retrieved from the database.

22. The system of claim 21, wherein the server further comprises a cache.

23. The system of claim 22, wherein the GUI further comprises a first user interface control to allow the user to activate one of the plurality of loyalty promotions.

24. The system of claim 23, wherein the LPE is operable to load the plurality of rules from the database into the cache after the loyalty promotion has been activated.

25. The system of claim 24, wherein the GUI further comprises a second user interface control to allow the user to deactivate the loyalty promotion.

26. The system of claim 25, wherein the LPE is operable to remove the plurality of rules from the cache after the loyalty promotion has been deactivated.

27. An apparatus comprising:
a graphical user interface (GUI) to allow a user to enter information for defining a loyalty program (LP), the information including a name of the LP, a start date, an end date, a plurality of loyalty promotions, a plurality of criteria, and a plurality of actions to be performed, wherein a plurality of rules are defined using the plurality of criteria and the plurality of actions; and
a first user interface control to allow the user to activate one of the plurality of loyalty promotions to cause a loyalty processing engine (LPE) to retrieve a plurality of transaction records from a database, to apply the plurality of rules to the plurality of transaction records, and to perform one or more of the plurality of actions if the plurality of transaction records meet the corresponding criteria.

28. The apparatus of claim 27, wherein the GUI comprises a plurality of fields to receive one of a plurality of attributes or a constant value.

29. The apparatus of claim 27, further comprising a second user interface control to allow the user to deactivate the loyalty promotion.
